(19) United States
(12) Patent Application Publication
(10) Pub. No.: US 2009/0070395 A1
(43) Pub. Date: Mar. 12, 2009

(54) INTERPOLATION FUNCTION GENERATION CIRCUIT

(75) Inventor: Yukio Koyanagi, Saitama (JP)

Correspondence Address: CONNOLLY BOVE LODGE & HUTZ LLP, 1875 EYE STREET, N.W., SUITE 1100, WASHINGTON, DC, 20006, US

(73) Assignee: Neuro Solution Corp., Tokyo (JP)

(21) Appl. No.: 12/281,722

(22) PCT Filed: Mar. 5, 2007
(86) PCT No.: PCT/JP2007/054745

§ 371 Date: Sep. 4, 2008

(30) Foreign Application Priority Data
Mar. 7, 2006 (JP) 2006-060703

(51) Int. Cl. G06F 17/17

(52) U.S. Cl. 708/313

(57) ABSTRACT

An interpolation function generation circuit is formed by cascade connecting a first FIR filter (10) having a numerical value string composed of a ratio “−α, α, β, β, α, −α” (α is an emphasis coefficient and β is a fixed value) as a filter coefficient and a second FIR filter (20) having a numerical value string composed of a ratio “1, 3, 5, . . . , m−1, m−1, . . . , 5, 3, 1” when the tap length is an odd number and “1, 3, 5, . . . , n−2, n−1, n−2, . . . , 5, 3, 1” if the tap length is an odd number (m and n are multiples of the oversampling). With only the two FIR filter (10, 20), it is possible to easily realize an interpolation function having a variable emphasis.

### TECHNICAL FIELD

The present invention relates to an interpolation function generation circuit, and in particular is suitable for use in an interpolation, function generation circuit using FIR digital filters.

### BACKGROUND ART

Conventionally, various methods have been proposed as data interpolation methods for obtaining a value between discrete data previously provided. One of the simplest methods is a linear interpolation method. In addition, there is also a method which carries out data interpolation using a predetermined interpolation function. The well-known interpolation function is a sine function. However, since the sine function is a function which converges to 0 when a variable is ±∞ the interpolation value obtained by an interpolation arithmetic operation using the sine function will include a truncation error, which has led to a problem of not being able to acquire an accurate interpolation value.

In an attempt to dealing with the problem, a method using a finite base function for carrying out data interpolation has been proposed as an alternative to the method using the sine function (for example, see Patent Documents 1 to 3). The finite base function is defined, as being able to be differentiated once in the whole area of the function, and having finite values other than 0 only within local areas and having a value of 0 in all the other areas. By carrying out an interpolation process using such a finite base interpolation function, only a limited number of data values should be considered in obtaining one certain interpolation value, by which amount of processing can be reduced to a great extent. What is more, it is also possible to prevent possible truncation errors from being generated.

Patent Document 1; Japanese Patent Laid-Open No. 2002-271204

Patent Document 2: Japanese Patent Laid-open No. 2002-366533

Patent Document 3: International Patent Application Publication No. WO00/79686

### DISCLOSURE OF THE INVENTION

However, with the technology as described in the above-mentioned Patent Documents 1 to 3, there has been a problem of not being able to make an emphasis level of the interpolation function variable by external input.

Meanwhile, as an algorithm for performing enlargement/reduction of an image with an interpolation function, there is one called a cubic convolution interpolation method. In the cubic convolution interpolation method, an interpolation function h(t) has impulse responses as expressed by the following cubic division polynomials.

h(t)=(a+2)|t|³−(a+3)|t|²+1 0≦|t|<1

h(t)=a|t|³−5a|t|²+8a|t|−4a 1≦|t|<2

h(t)=0 2≦|t|

As can be noted in the above expressions, in the cubic convolution interpolation method, a constant ‘a’ is used. By making a value of constant ‘a’ variable, it is possible to make the emphasis level of the interpolation function variable, and such arrangement can be made possible by a DSP (digital signal processor). With this arrangement, however, it has been a problem that a circuit size should become larger.

It is an object of the present invention to solve such problems and to enable, with a simple configuration, to generate a finite base interpolation function with a variable emphasis which is capable of being differentiated for one or more times in the whole area.

In order to solve the problems as mentioned above, an interpolation function generation circuit of the present invention is configured by cascade connecting a first FIR filter having a numerical value string composed of a ratio “−α, α, β, β, α, −α” (α and β are arbitrary coefficients with a value of 0 or greater) as a filter coefficient and a second FIR filter having a numerical value string composed of a ratio “1, 3, 5, . . . , m−1, m−1, . . . , 5, 3, 1” (m is an arbitrary even number greater than or equal to 2) or a numerical value string composed of a ratio “1, 3, 5, . . . , n−2, n−1, n−2, . . . , 5, 3, 1” (n is an arbitrary odd number greater than or equal to 3) as a filter coefficient.

According to another aspect of the present invention, the first FIR filter is provided with an emphasis arithmetic section which, with respect to a filter coefficient of a numerical value string composed of a ratio “−1, 1, β, β, 1, −1”, conducts an emphasis arithmetic operation on the base of an emphasis coefficient α being inputted, deriving a relation “−α, α, β, β, α, −α”. Moreover, the second FIR filter is provided at its input stage with an oversampling circuit which conducts oversampling of m-fold or n-fold with respect to input data.

According to the present invention as configured in the above-described manner, by using two cascade connected FIR filters, it is possible to easily realize a finite base interpolation function with a variable emphasis which is capable of being differentiated for one or more times in the whole area.

### BRIEF DESCRIPTION OF THE DRAWINGS

FIG. 1 is a diagram showing one configuration example of an interpolation function generation circuit according to an embodiment of the present invention;

FIG. 2 is a diagram showing a configuration example of a first FIR filter according to the embodiment of the present invention;

FIG. 3 is a diagram showing an example of a frequency characteristic of the first FIR filter according to the embodiment of the present invention;

FIG. 4 is a diagram showing a configuration example of a second FIR filter according to the embodiment of the present invention;

FIG. 5 is a diagram showing interpolation functions generated by the interpolation function generation circuit according to the embodiment of the present invention;

FIG. 6 is a diagram for explaining a conventional arithmetic operation for obtaining an interpolation function when a tap length is an even number;

FIG. 7 is a diagram for explaining an arithmetic operation for obtaining an interpolation function when a tap length is an even number, according to the embodiment of the present invention;

FIG. 8 is a diagram for explaining a conventional arithmetic operation for obtaining an interpolation function when a tap length is an odd number; and

FIG. 9 is a diagram for explaining an arithmetic operation for obtaining an interpolation function when a tap length is an odd number, according to the embodiment of the present invention.

### BEST MODE FOR CARRYING OUT THE INVENTION

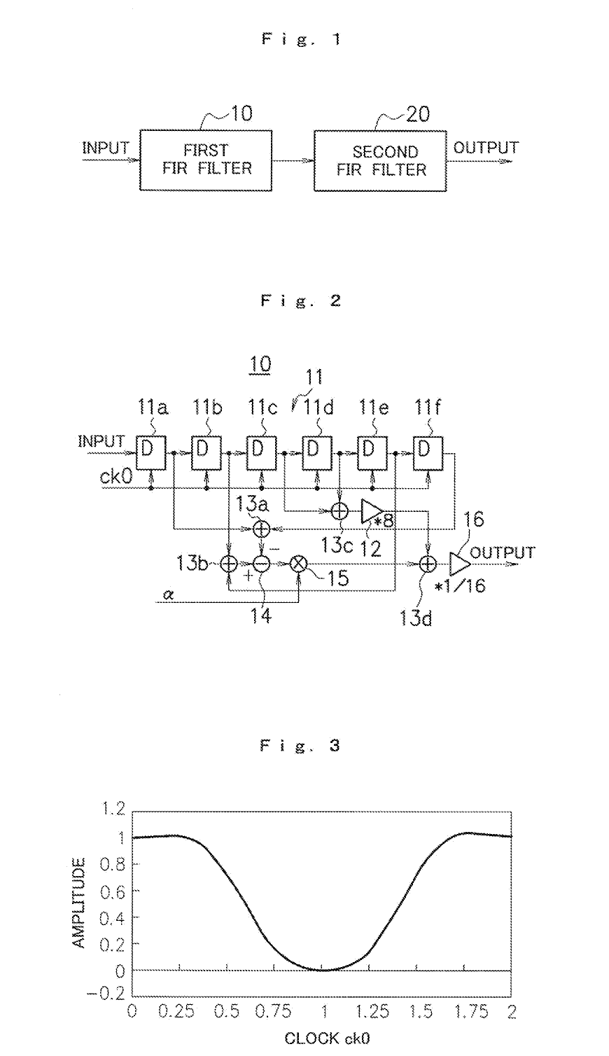

In the following, one embodiment of the present invention will be described with reference to the drawings. FIG. 1 is a diagram showing a configuration example of an interpolation function generation circuit according to the embodiment of the present invention. As can be seen in FIG. 1, the interpolation function generation circuit according to the embodiment of the present invention is configured in a way such that a second. FIR filter 20 is cascade connected with a first FIR filter 10 at a latter stage of the first FIR filter 10.

FIG. 2 is a diagram showing a configuration example of the first FIR filter 10. In the first FIR filter 10, input data is sequentially delayed by a delay line 11 with taps composed of six D type flip-flops 11a to 11f, and six data outputted from output taps of the D type flip-flops 11a to 11f, respectively, are multiplied by a filter coefficient as being a numerical value string “−α, α, β, β, α, −α” (α and β are arbitrary coefficients with a value of 0 or greater; 3=8, for example) of which multiplication results are added together to be outputted.

That is, the first FIR filter 10 is composed of the delay line 11 with taps having the six cascade connected D type flip-flops 11a to 11f, a single coefficient unit 12, four adders 13a to 13d, a single subtracter 14, a single multiplier 15, and a single amplitude adjuster 16.

Each of the six D type flip-flops 11a to 11f functions to sequentially delay the input data by one clack each according to a clock ck0 of a reference frequency. The single coefficient unit 12, four of the adders 13a to 13d and the single subtracter 14 function to multiply the six data outputted from, the output taps of the D type flip-flops 11a to 11f, respectively, by a filter coefficient as being a numerical value string “−1, 1, 8, 8, 1, −1” and add all the multiplication results together.

The single multiplier 15 functions to multiply the “−1, 1” part and the “1, −1” part in the above-mentioned numerical value string by an emphasis coefficient α inputted from outside. More specifically, the multiplier 15 functions as an emphasis arithmetic section which, with respect to the filter coefficient as being the numerical, value string “−1, 1, 8, 8, 1, −1”, carries out an emphasis arithmetic operation based on the emphasis coefficient α deriving a relation “−α, α, 8, 8, α, −α”.

When multiplication and addition on the basis of the filter coefficient are carried out with respect to the six data outputted from the output taps of the D type flip-flops 11a to 11f, respectively, as described above, amplitude of the input data becomes 16 times the original (=(−α)+α+8+8+α+(−α)). The single amplitude adjuster 16 functions to restore the 16-fold amplitude to the original amplitude. When the filter coefficient is {−α, α, β, β, α, −α}, on the other hand, amplitude of the input data becomes 2β times the original due to the multiplication and addition of the filter coefficient. In this case, the amplitude adjuster 16 functions to restore the 2β-fold amplitude to the original amplitude.

The first FIR filter 10, configured as described above with reference to FIG. 2, is a low-pass filter, and its frequency characteristic is as shown in FIG. 3. FIG. 3 shows a frequency characteristic in a case when a value of the emphasis coefficient α is 1. A passband of the low-pass filter becomes flat when the value of the emphasis coefficient α is 0 (i.e. a state in which neither overshoot nor undershoot occurs), and as the value of the emphasis coefficient α becomes larger, an amplitude value of a passband edge increases, resulting in causing an overshoot.

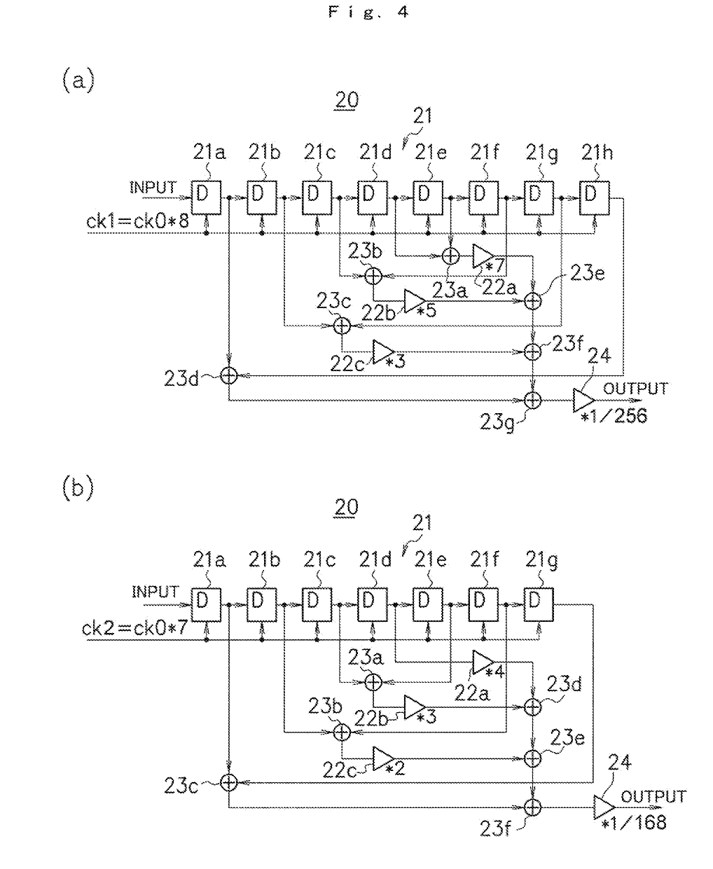

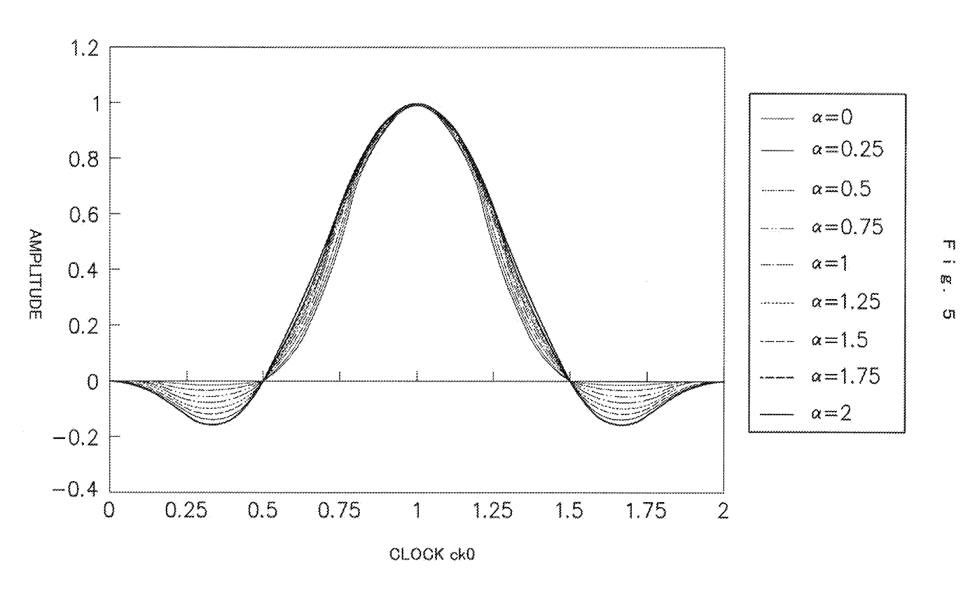

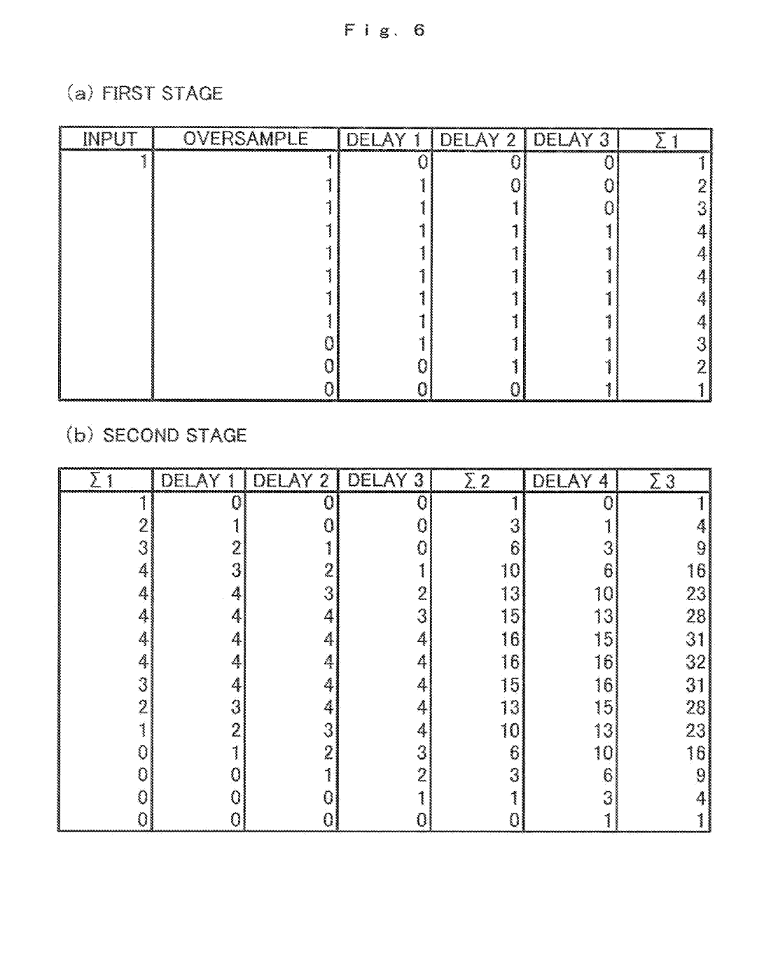

FIG. 4 is a diagram showing a configuration example of the second FIR filter 20. In the same way as the first FIR filter 10, the second FIR filter 20 functions to have input data sequentially delayed by a delay line with taps having multiple D type flip-flops, have the multiple data outputted from output taps of the respective multiple D type flip-flops multiplied by a predetermined filter coefficient, and have the multiplication results added together to be outputted.

The second FIR filter 20 is an oversampling smoothing filter, and it uses different filter coefficients depending on a multiplying factor of oversampling and on whether a number of impulse responses (tap length) is an even number or odd number. FIG. 4(a) shows a configuration example of the second FIR filter 20 in a case when the number of impulse responses is an even number, and FIG. 4(b) shows a configuration example of the second FIR filter 20 in a case when the number of impulse responses is an odd number.

In the case when the number of impulse responses (oversampling multiplying factor m) is set as an even number, and m is 8, for example, the second FIR filter 20 should, be composed of a delay line 21 with taps having eight cascade connected D type flip-flops 21a to 21h, three coefficient units 22a to 22c, seven adders 23a to 23g, and a single amplitude adjuster 24.

Each of the eight D type flip-flops 21a to 21h functions to sequentially delay the input data by one clock each according to a clock ck1 (=8×ck0) of m-fold (eight-fold in this case) frequency. Sequentially delaying the input data by one clock each according to the clock ck1 of eight-hold frequency means conducting oversampling of eight-fold with respect to the input data. Therefore, the delay line 21 with taps provided at an input stage of the second FIR filter 20 functions as an oversampling circuit which performs oversampling of eight-fold with respect to the input data. In a case when the input data is “1”, the output data of the delay line 21 with taps will be “1, 1, 1, 1, 1, 1, 1, 1” as oversampling of four-fold is conducted by the delay line 21 with taps.

Three of the coefficient units 22a to 22c and seven of the adders 23a to 23g function to multiply the eight data outputted from the output taps of the D type flip-flops 21a to 21h, respectively, by a filter coefficient as being a numerical value string “1, 3, 5, m−1, m−1, . . . , 5, 3, 1” (“1, 3, 5, 7, 7, 5, 3, 1” in this case) and add all the multiplication results together. The meaning of this numerical value string will be described later on.

When multiplication and addition on the basis of the filter coefficient are carried out with respect to the eight data outputted from the output taps of the D type flip-flops 21a to 21h, respectively, as described above, amplitude of the input data becomes 32 times the original (=(7+5+3+1)×2). In addition, to that, since the amplitude is further increased by m times (eight times) by the oversampling, a multiplying factor of the amplitude in the second FIR filter 20 as including the one with the oversampling will become 256. The amplitude adjuster 24 provided at an output stage of the second FIR filter 20 functions to restore the 256-fold amplitude to the original amplitude.

On the other hand, in the case when the number of impulse responses (oversampling multiplying factor n) is set as an odd number, and n is 7, for example, the second FIR filter 20 should be composed of a delay line 21 with taps having seven cascade connected D type flip-flops 21a to 21g, three coefficient units 22a to 22c, six adders 23a to 23f, and a single amplitude adjuster 24.

Each of the seven D type flip-flops 21a to 21g functions to sequentially delay the input data by one clock each according to a clock ck2 of seven-fold frequency. Three of the coefficient units 22a to 22c and six of the adders 23a to 23f function to multiply the seven data outputted from the output taps of the D type flip-flops 21a to 21g, respectively, by a filter coefficient as being a numerical value string “1, 3, 5, . . . , n−2, n−1, n−2, . . . , 5, 3, 1” (“1, 3, 5, 6, 5, 3, 1” in this case) and add all the multiplication results together. The meaning of this numerical value string will also be described later on.

When multiplication and addition on the basis of the filter coefficient are carried out with respect to the seven data outputted from the output taps of the D type flip-flops 21a to 21g, respectively, as described above, amplitude of the input data becomes 24 times the original (=6+(5+3+1)×2). In addition to that, since the amplitude is further increased by n times (seven times), a multiplying factor of the amplitude in the second FIR filter 20 as including the one with the oversampling will become 168. The amplitude adjuster 24 provided at an output stage of the second FIR filter 20 functions to restore the 168-fold amplitude to the original amplitude.

FIG. 5 is a diagram showing output waveforms when a unit pulse with an amplitude of 1 is inputted as input data to the interpolation function generation circuit, the interpolation function generation circuit being configured as having the first FIR filter 10 shown in FIG. 2 and the second FIR filter 20 shown in FIG. 4(b) cascade connected. In this case, several kinds of response characteristics corresponding to changes of the emphasis coefficient α as a parameter are shown.

Any of the output waveforms shown in FIG. 5 is a finite base function even though the emphasis coefficient α is being changed. That is, the output waveforms shown in FIG. 5 can be differentiated for one or more times in the whole area, and at positions; ck0≦0, ck0= 0.5, ck0=1.5 and ck0≦2, corresponding amplitude values are always 0 regardless of the value of the emphasis coefficient α, while at a position ck0=1, corresponding amplitude values are always 1 regardless of the value of the emphasis coefficient α. On the other hand, only within local areas in a range of 0<ck0<2, the output waveforms have finite amplitude values and have smooth curves. Accordingly, these output waveforms can be used as interpolation functions. As shown in FIG. 5, by changing the value of the emphasis coefficient α, it is possible to continuously change the emphasis level of the interpolation function while having the amplitude value of the impulse response fixed to 0 at positions where the reference clock ck0 is 0, 0.5, 1.5, and 2.

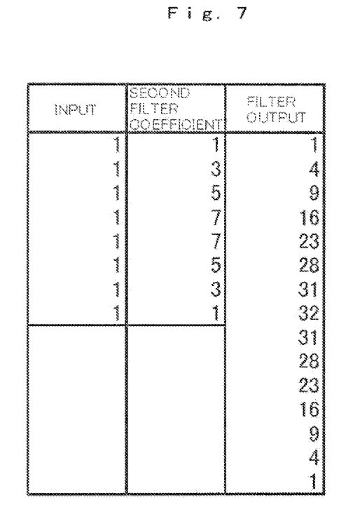

Now, a technical meaning of the numerical value string “1, 3, 5, m−1, m−1, 5, 3, 1” (m is an even number greater than or equal to 2) will be described. In the above-mentioned Patent Document 3, oversampling is conducted with respect to the numerical value string and a moving average arithmetic operation is continuously performed on the resultant numerical, value string in order to obtain an interpolation function. FIG. 6 is a diagram showing one example of an arithmetic operation for deriving an interpolation function according to a method as described in Patent Document 3.

In the method of Patent Document 3, first, in a process at a first stage shown in FIG. 6(a), oversampling of eight-fold (even number times) is carried out with respect to a unit pulse with, an amplitude value “1”, and the resultant numerical value string “1, 1, 1, 1, 1, 1, 1, 1” is to be sequentially delayed by one clock each throughout three stages (FIG. 6 shows that the clock is proceeding one by one in a top-to-bottom direction). Then, by adding up four numerical values at each clock position (four numerical values lined up in the same horizontal row as shown in FIG. 6(a)), a numerical value string Σ1 “1, 2, 3, 4, 4, 4, 4, 4, 3, 2, 1” can be obtained.

Next, in a process at a second stage shown in FIG. 6(b), the numerical value string Σ1 obtained in the above-described manner is to be delayed by one clock each throughout three stages. Then, by adding up four numerical values at each clock position, a numerical value string Σ2 can be obtained. This numerical value string Σ2 is further delayed by one clock, and by adding up two numerical values at each clock position, a numerical value string Σ3 can be obtained. This numerical value string Σ3 will be a finite base interpolation function.

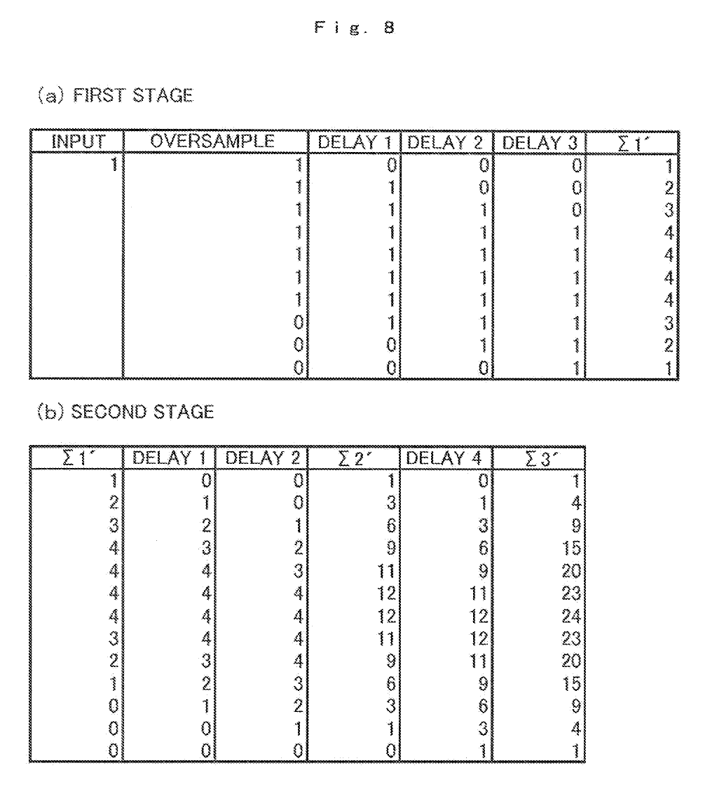

On the other hand, one example of an arithmetic operation for deriving an interpolation function according to a method of the embodiment of the present invention will be described with reference to FIG. 7. In the present embodiment, although the filter coefficient that the first FIR filter 10 has is supposed to be “−α, α, β, β, α, −α”, the filter coefficient in this case will be considered as “1, 1, 1, 1, 1, 1, 1, 1” so that comparison with the conventional example shown in FIG. 6 can be made easily. As described above, when the number of impulse responses (tap length; of the second FIR filter 20 is eight, the filter coefficient that the second FIR filter 20 has will be “1, 3, 5, 7, 7, 5, 3, 1”.

In a case of having the first FIR filter 10 of which filter coefficient is set as “1, 1, 1, 1, 1, 1, 1, 1” and the second FIR filter 20 of which filter coefficient is set as “1, 3, 5, 7, 7, 5, 3, 1” cascade connected, when a unit pulse with an amplitude value “1” is inputted to the first FIR filter 10, a numerical value string to be outputted from the second FIR filter 20 will be the same as the numerical value string Σ3 in FIG. 6, as shown in FIG. 7. That is, when a predetermined product-sum operation is carried out between the numerical value string “1, 1, 1, 1, 1, 1, 1, 1” and the numerical value string “1, 3, 5, 7, 7, 5, 3, 1”, the same numerical value string as the numerical value string Σ3 shown in FIG. 6 is to be outputted.

Specifically, the product-sum operation to be carried cut in this case is to be like what will be described in the following. With respect to the filter coefficient “1, 3, 5, 7, 7, 5, 3, 1” of the second FIR filter 20, these eight numerical values are fixed to be subjected to multiplication and addition at all times. On the other hand, with respect to the input data to the second FIR filter 20 (i.e. the filter coefficient “1, 1, 1, 1, 1, 1, 1, 1” of the first FIR filter 10), it is to be assumed that there are numerical value strings of “0s” in front and back of it, and a numerical value string of eight numerical values also including such 0s is to be subjected to the product-sum operation. In obtaining the i-th numerical value (i=1, 2, 3, . . . , 15) in the output data of the second FIR filter 20, a numerical value string consisting of eight numerical values including the i-th numerical value in the input data and the ones just before the i-th is to be subjected to multiplication and addition.

For example, in obtaining the first numerical value in the output data of the second FIR filter 20, eight filter coefficients “1, 3, 5, 7, 7, 5, 3, 1” of the second FIR filter 20 and a numerical value string “0, 0, 0, 0, 0, 0, 0, 1” consisting of eight numerical values including the first numerical value in the input data and the ones just before the first are to be subjected to the arithmetic operation which adds up products of corresponding elements in the subject numerical value strings. Therefore, in this case, a result of the arithmetic operation will be (1×1=1).

Moreover, in obtaining the second numerical value in the output data of the second FIR filter 20, the eight filter coefficients “1, 3, 5, 7, 7, 5, 3, 1” of the second FIR filter 20 and a numerical value string (0, 0, 0, 0, 0, 0, 0, 1, 1) consisting of eight numerical values including the second numerical value in the input data and the ones just before the second are to be subjected to the arithmetic operation which adds up products of corresponding elements in the subject numerical value strings. Therefore, in this case, a result of the arithmetic operation will be (1×1+1×3=4).

When the same arithmetic operations are performed with respect to the other third to 15th numerical values, a numerical value string as shown in the very right column in FIG. 7 can be obtained.

As described above, according to the embodiment of the present invention, the numerical value string Σ3 which could be obtained by the moving average arithmetic operation in conventional cases as shown in FIG. 6, can be obtained easily by just having the first FIR filter 10 and the second FIR filter 20 cascade connected. Practically, the input data to the second FIR filter 20 is not “1, 1, 1, 1, 1, 1, 1”, but a numerical value string of which amplitude is being processed by the filter coefficient “−α, α, β, β, α, −α” that the first FIR filter 10 has. By using such input data, it is possible to obtain a numerical value string as an interpolation function which can interpolate between discrete data more smoothly, and in addition, it is also possible to put variable emphasis on the interpolation function by using the emphasis coefficient α.

Now, a technical meaning of the numerical value string “1, 3, 5, . . . , n−2, n−1, n−2, . . . , 5, 3, 1” (n is an odd number greater than or equal to 3) used in the case when the number of impulse responses is an odd number will be described. FIG. 8 is a diagram showing one example of an arithmetic operation for deriving an interpolation function according to a method as described in Patent Document 3.

In the method of Patent Document 3, first, in a process at a first stage shown in FIG. 8(a), oversampling of seven-fold Soda number times) is carried out with respect to a unit pulse with an amplitude value “1”, and the resultant numerical value string “1, 1, 1, 1, 1, 1, 1” is to be sequentially delayed by one clock each throughout three stages. Then, by adding up four numerical values at each clock position, a numerical value string Σ1′ “1, 2, 3, 4, 4, 4, 4, 3, 2, 1” can be obtained.

Next, in a process at a second stage shown in FIG. 8(b), the numerical value string Σ1′ obtained in the above-described manner is to be delayed by one clock each throughout three stages. Then, by adding up four numerical values at each clock position, a numerical value string Σ2′ can be obtained. This numerical value string Σ2′ is further delayed by one clock, and by adding up two numerical values at each clock position, a numerical value string Σ3′ can be obtained. This numerical value string Σ3′ will be a finite base interpolation function.

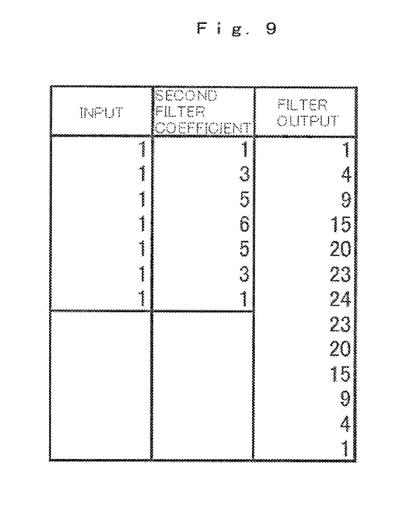

On the other hand, one example of an arithmetic operation for deriving an interpolation function according to a method of the embodiment of the present invention will be described with reference to FIG. 9. In the present embodiment, although the filter coefficient that the first FIR filter 10 has is supposed to be “−α, α, β, β, α, −α”, the filter coefficient in this case will be considered as “1, 1, 1, 1, 1, 1, 1” so that comparison with the conventional example shown, in FIG. 8 can be made easily. As described above, when the number of impulse responses of the second FIR filter 20 is seven, the filter coefficient that the second FIR filter 20 has will be “1, 3, 5, 6, 5, 3, 1”.

In a case of having the first FIR filter 10 of which filter coefficient is set as “1, 1, 1, 1, 1, 1, 1” and the second FIR filter 20 of which filter coefficient is set as “1, 3, 5, 6, 5, 3, 1” cascade connected, when a unit pulse with an amplitude value “1” is inputted to the first FIR filter 10, a numerical value string to be outputted from the second FIR filter 20 will be the same as the numerical value string 3′ in FIG. 8, as shown in FIG. 9. That is, when a predetermined product-sum operation as the one mentioned above is carried out between the numerical value string “1, 1, 1, 1, 1, 1, 1” and the numerical value string “1, 3, 5, 6, 5, 3, 1”, the same numerical value string as the numerical value string Σ3′ shown in FIG. 8 is to be outputted.

As described above, according to the embodiment of the present invention, the numerical value string Σ3′ which could be obtained by the moving average arithmetic operation in conventional cases as shown in FIG. 8, can be obtained easily by just having the first FIR filter 10 and the second FIR filter 20 cascade connected. Practically, the input data to the second FIR filter 20 is not “1, 1, 1, 1, 1, 1, 1”, but a numerical value string of which amplitude is being processed by the filter coefficient “−α, α, β, β, α, −α” that the first FIR filter 10 has. By using such input data, it is possible to obtain a numerical value string as an interpolation function which can interpolate between discrete data more smoothly, and in addition, it is also possible to put variable emphasis on the interpolation function by using the emphasis coefficient α.

As described in detail, according to the embodiment of the present invention, by using the two cascade connected FIR filters 10 and 20 as shown in FIG. 1, it is possible to easily realize a finite base interpolation function with variable emphasis which is capable of being differentiated for one or more times in the whole area. By such arrangement, it is possible to significantly simplify the circuit configuration as compared to those interpolation function generation circuits applying the techniques in Patent Documents 1 to 3 or the cubic convolution interpolation method. Furthermore, since the present invention requires only simple FIR arithmetic operations to be carried out, it is possible to shorten the time required for the interpolation process.

In the above-described embodiment of the present invention, the description has been given about the case in which the interpolation process is carried out by conducting oversampling of m-fold or n-fold with respect to the input data, in accordance with the tap length m or n of the second FIR filter 20. However, the present, invention is not limited to this.

Moreover, in the above-described embodiment of the present invention, the description has been given about the case in which, with respect to the filter coefficient of the numerical value string composed of the ratio “−1, 1, β, β, 1, −1”, the emphasis arithmetic operation based on the emphasis coefficient α is conducted deriving a relation “−α, α, β, β, α, −α”. However, the emphasis arithmetic operation according to the present invention is not limited to this. Any kind of emphasis arithmetic operation can be carried out as long as the sum total (=2β) of the numerical value strings becomes invariable regardless of whether there is emphasis or not. In such cases, however, it is preferable that the coefficient values “β, β” in the middle of the numerical value string be always fixed regardless of whether there is emphasis or not.

The above-described embodiment of the present invention is merely an illustrative example in the practice of the present invention, and it is to be understood that the technical scope of the present invention should not be interpreted in a limited manner by this. In other words, the present invention can be practiced in various forms without departing from the spirit or the main features thereof.

### INDUSTRIAL APPLICABILITY

The present invention proves useful as applied to an interpolation function generation circuit using FIR filters. The interpolation function generation circuit according to the present invention can be applied to all kinds of circuits and devices which require data interpolation. For instance, the interpolation function generation circuit according to the embodiment of the present invention can be applied to a circuit producing high-definition images for improving quality of images. Moreover, if can also be applied to a circuit for conducting image enlargement/reduction processes. Furthermore, it can also be applied to a circuit for improving quality of audio signals, a circuit for decompressing compressed data, and so forth.

1. An interpolation function generation circuit, comprising:
a first FIR filter having a numerical value string composed of a ratio “−α, α, β, β, α, −α” (α and β are arbitrary coefficients with a value of 0 or greater) as a filter coefficient, and
a second FIR filter having a numerical value string composed of a ratio “1, 3, 5, . . . , m−1, m−1, . . . , 5, 3, 1” (m is an arbitrary even number greater than or equal to 2) or a numerical value string composed of a ratio “1, 3, 5, . . . , n−2, n−1, n−2, . . . , 5, 3, 1” (n is an arbitrary odd number greater than or equal to 3) as a filter coefficient,
the second FIR filter being cascade connected with the first FIR filter at a latter stage of the first FIR filter.

2. The interpolation function generation circuit according to claim 1,
the first FIR filter has an emphasis arithmetic section which, with respect to a filter coefficient of a numerical value string composed of a ratio “−1, 1, β, β, 1, −1”, conducts an emphasis arithmetic operation on the basis of an emphasis coefficient α inputted, deriving a relation “−α, α, β, β, α, −α”.

3. The interpolation function generation circuit according to claim 2,
the emphasis coefficient α is variable in the first FIR filter.

4. The interpolation function generation circuit according to claim 1,
the second FIR filter has an oversampling circuit at its input stage, the oversampling circuit conducting oversampling of m-fold or n-fold with respect to input data.

5. The interpolation function generation circuit according to claim 1,
the second FIR filter has an oversampling smoothing circuit in which an operation clock frequency is set to m times or n times an operation clock frequency of the first FIR filter.
